(19) United States
(12) Patent Application Publication
(10) Pub. No.: US 2015/0123924 A1
(43) Pub. Date: May 7, 2015

(54) TOUCH DISPLAY DEVICE AND TOUCH DEVICE

(71) Applicants: Interface Optoelectronics (Shenzhen) Co., Ltd., Shenzhen City (CN); GENERAL INTERFACE SOLUTION LIMITED, Miaoli County (TW)

(72) Inventors: Chen-Hsing Huang, New Taipei City (TW); Ying-Hung Tsai, Taoyuan County (TW); De-Ching Shie, Hsinchu County (TW)

(21) Appl. No.: 14/555,551

(22) Filed: Nov. 26, 2014

(30) Foreign Application Priority Data
Oct. 27, 2014 (CN) 201410584339.3

(51) Int. Cl. G06F 3/041; G06F 1/16

(52) U.S. Cl. CPC G06F 3/0412; G06F 1/1643
USPC 345/173

(57) ABSTRACT

A touch display device includes a display device and a touch device disposed on the display device. The touch device includes a cover, a dummy structure and a touch sensing element. The touch sensing element is disposed between the cover and the dummy structure in a way that one surface of the touch sensing element is completely covered by the dummy structure.

### BACKGROUND OF THE INVENTION

1. Field of the Invention

The present invention relates generally to the field of touch devices, and more particularly to touch display devices with out-cell touch devices and out-cell touch devices.

2. Description of the Prior Art

Touch panels have been widely used in various external input devices of electronic equipment. In recent years, with the flourishing development of the consumer electronics, there are many display devices in combination with touch sensing functions, such as mobile phones, GPS navigator system, tablet PCs, personal digital assistants (PDA), and laptop PC. In these consumer electronics, out-cell touch panels, in which touch panels are adhered to display panels, are widely used in current global touch panel industry.

FIG. 1 is a cross-sectional diagram showing a conventional touch display device. A touch display device 10 includes at least a display device 12, a touch device 14 and an adhesion layer 16. The display device 12 and the touch device 14 are two oppositely disposed independent devices and are combined with each other through an adhesion process. The display device 12 may be secured by a frame 18 and the touch device 14 may be adhered to the frame 18 by the adhesion layer 16. Specifically, the main purpose of the display device 12 is to provide images and the main purpose of the display device 12 is to provide touch sensing function. In detail, the touch device 14 includes at least a touch sensing element 20, such as a capacitive touch sensing element, and a cover 22, such as a cover glass. The cover 22 may protect the touch sensing element 20 and enhance the mechanical property of the entire touch device 14, which makes the touch device 14 less likely to be fractured. For the out-cell touch display device 10 shown in FIG. 1, in order to ensure that the mechanical strength of the cover 22 is high enough to protect the touch device 14, the thickness T of the cover 22 is often greater than a certain value.

Although the above-mentioned device is widely used in large-size out-cell touch display devices, it still has some drawbacks needing to be overcome. For example, in order to avoid the fracture of the touch device 14 during an adhesion process or operation, the thickness T of the cover 22 is often greater than a certain value, such as greater than 4 mm. However, when the cover 22 becomes thicker, the touch sensing element 20 becomes less sensitive to a touch from the exterior of the cover 22. On the other hand, the reduction in the thickness T of the cover 22 may lead to the decrease in the mechanical strength of the touch device 14, which causes the fracture of the display device 12 during the corresponding assembling process.

Therefore, there is still a need to provide touch display devices with robust mechanical strength and high sensitivity so as to overcome above-mentioned drawbacks.

### SUMMARY OF THE INVENTION

To this end, the present invention provides several embodiments in order to solve the problems of the conventional techniques.

According to one embodiment of the present invention, a touch display device is provided. The touch display device includes a display device and a touch device disposed on the display device. The touch device includes a cover, a dummy structure and a touch sensing element. The touch sensing element is disposed between the cover and the dummy structure in a way that one surface of the touch sensing element is completely covered by the dummy structure.

According to another embodiment of the present invention, a touch device is provided. The touch device includes a cover, a dummy structure and a touch sensing element. The touch sensing element is disposed between the cover and the dummy structure in a way that one surface of the touch sensing element is completely covered by the dummy structure. The dummy structure further includes an adhesion surface adhered to a display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional diagram showing a conventional touch display device.

FIG. 2 is a schematic cross-sectional diagram showing a touch display device in accordance with a first embodiment of the present invention.

FIG. 3 is a schematic top view showing a layout of touch sensing elements in accordance with a first embodiment of the present invention.

FIG. 4 is a schematic top view showing a layout of touch sensing elements in accordance with another embodiment of the present invention.

FIG. 5 is a schematic cross-sectional diagram showing a touch display device in accordance with a second embodiment of the present invention.

### DETAILED DESCRIPTION

To provide a better understanding of the present invention to the skilled users in the art, preferred embodiments are detailed as follows. The preferred embodiments of the present invention are illustrated in the accompanying drawings with numbered elements to elaborate the contents and effects to be achieved. It should be noted that all the figures are diagrammatic. Relative dimensions and proportions of parts of the drawings have been shown exaggerated or reduced in size, for the sake of clarity and convenience in the drawings. The actual dimensions and proportions of parts of the drawings may be modified in accordance with the specific requirements.

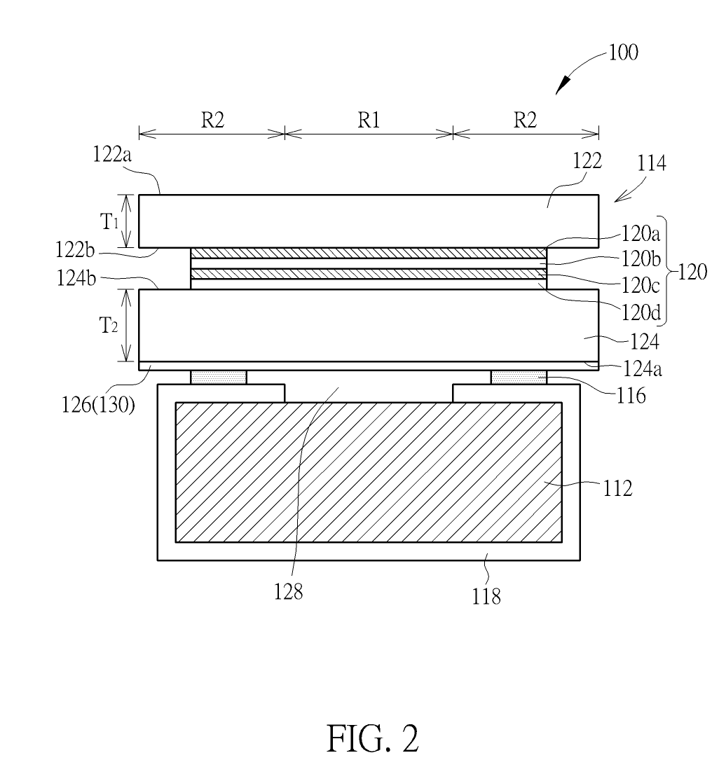

FIG. 2 is a schematic cross-sectional diagram showing a touch display device in accordance with a first embodiment of the present invention. A touch display device 100 shown in FIG. 2 includes a viewing region R1 and a peripheral region R2. The peripheral region R2 is on at least one side of the viewing region R1 and preferably surrounding the periphery of the viewing region R1. The viewing region R1 is a region for display images, while the peripheral region R2 is a region for outer trace lines. The touch display device 100 includes a display device 112 and a touch device 114, which may be used to provide images and touch sensing function respectively. These two devices are preferably independently fabricated and then combined with each other through an adhesion layer 116, such as an annular adhesive or functional adhesive. Also, a frame 118 may be disposed around the periphery of the display device 112 so that the touch device 114 may be fixed to the display device 112 by adhering it to the frame 118. Optionally, the frame 118 may also encapsulate both the touch device 114 and the display device 112. In this case, the touch device 114 is directly adhered to the display device 112, and a chamber 128 is disposed between them. According to other design requirements, the adhesion layer 116 may optionally fill up the chamber 128 between the display device 112 and touch device 114. The aforementioned display device 112 may include a liquid crystal display device, an organic light emitting display device, an electrowetting display device, an E-ink display device, a plasma display device, or another suitable display device.

Furthermore, the touch device 114 may include a cover 122, a dummy structure 124 and a touch sensing element 120. The touch sensing element 120, which is used to perform touch sensing function, may be disposed between the cover 122 and the dummy structure 124. The cover 122 may include an external surface 122a, used to receive a touch pressure from the exterior, and an inner surface 122b disposed opposite to the external surface 122a, on which the touch sensing element 120 is directly disposed. Additionally, the cover 122 may also be used to avoid the touch sensing element 120 from directly contacting the external environment and to enhance the entire mechanical strength of the touch device 114. The dummy structure 124 is disposed between the touch sensing element 120 and the display device 112, and its cover surface 124b may completely cover one surface of the touch sensing element 120. Preferably, the area of the dummy structure 124 may be substantially equal to that of the cover 122. That is to say, portions of the dummy structure 124 may be disposed outside the viewing region R1 and therefore cover the peripheral region R2. The dummy structure 124 may also be used to avoid the touch sensing element 120 from directly contacting the external environment and to enhance the entire mechanical strength of the touch device 114. Additionally, in order to enhance the anti-glare or anti-reflection abilities of the touch device 114, additional single-layered or multi-layered optical layers 126, such as anti-reflection layers and/or anti-glare layers, may be optionally disposed on one surface or both surfaces of the dummy structure 124, such as an adhesion surface of the dummy structure 124. In addition, a device layer, such as a layer including photodetection devices, photovoltaic devices and/or trace lines, may be disposed on these surfaces. Light with image information emitted from the display device is preferably not absorbed by the optical layer 126 and/or the device layer in the viewing region R1.

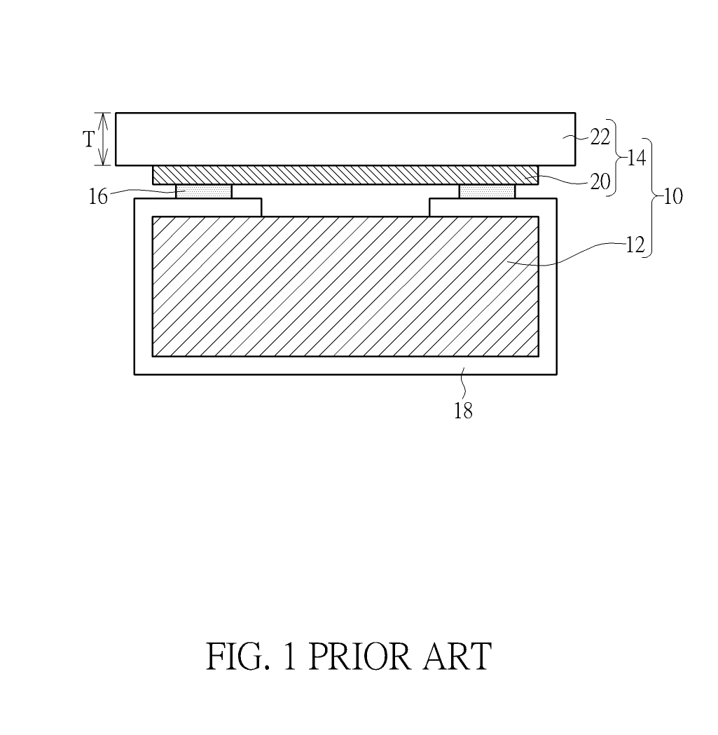

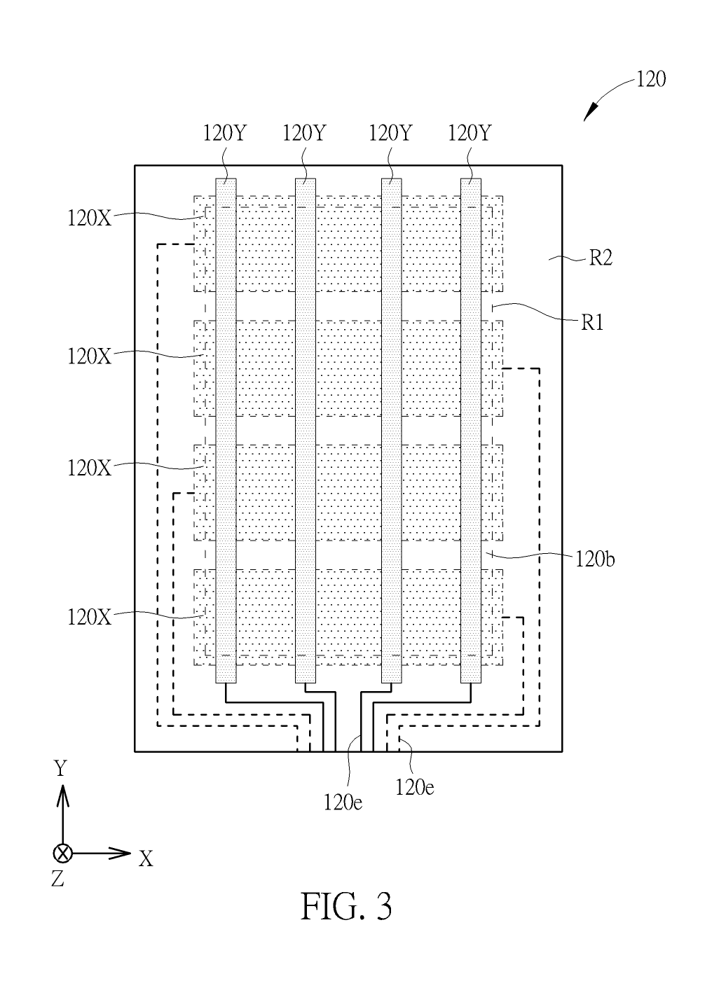

For a capacitive touch sensing element 120, the thickness T1 of the cover 122 often affects the capacitance between its external surface 122a and the touch sensing element 120. Specifically, the touch sensitivity of the touch device 114 is inversely proportional to the thickness T1 of the cover 122. In this case, for example, when the thickness T1 of the cover 122 becomes thinner, the touch sensitivity of the touch device 114 becomes higher, and vice versa. Therefore, one feature of the present embodiment is that the dummy structure 124 is disposed in the touch device 114 in a way that the touch sensing element 120 is disposed between the cover 122 and the dummy structure 124. Referring to FIG. 1 and FIG. 3, when the thickness T of the cover 22 in FIG. 1 is equal to the total thickness of the cover 122 and the dummy structure 124 in FIG. 3, such as thickness T1 plus thickness T2, the touch devices 14 and 114 may have equal mechanical strength. However, because the thickness T1 of the cover 122 is thinner than the thickness T of the cover 22, the touch device 114 shown in FIG. 3 may have higher touch sensitivity than that of the touch device 14 shown in FIG. 1. The proportion of the thickness T1 of the cover 122 to the thickness T2 of the dummy structure 124 is not limited to a certain value. Preferably, the thickness T1 of the cover 122 is less than or equal to the thickness T2 of the dummy structure 124, and the thickness T1 of the cover 122 is between 0.2 mm to 2 mm, but not limited thereto. The cover 112 and the dummy structure 124 may be chosen from transparent substrates, and one or both of them may be thin substrates with a thickness less than 0.25 mm, such as glass substrates, thin plastic substrates, thin glass-plastic composite substrates or other thin substrates with suitable compositions, regular substrate with a thickness between 0.25 mm and 4 mm, such as glass substrates, plastic substrates, or other suitable substrates.

For the capacitive touch sensing element 120 shown in FIG. 2, it may be directly fabricated on the inner surface 122b of the cover 122, and it may include a first axis electrodes layer 120a, a first insulating structure 120b, a second axis electrode layer 120c and a second insulating structure 120d, which are sequentially stacked on the inner surface 122b of the cover 122, but not limited thereto. Additionally, the touch sensing element 120 may also include a plurality of trace lines for transmitting touch signals out of or to the touch sensing element 120. The structure of the capacitive touch sensing element 120 is disclosed in detail in the following paragraphs. The structure disclosed below is for illustration only and should not be construed in a limiting sense.

FIG. 3 is a schematic top view showing a layout of touch sensing elements in accordance with a first embodiment of the present invention. As shown in FIG. 3, the touch sensing element 120 may also include a plurality of first axis electrodes 120X and a plurality of second axis electrodes 120Y. The first axis electrodes 120X extend along a first direction X, and the second axis electrodes 120Y extend along a second direction Y. Each of the first axis electrodes 120X at least partially overlaps each of the second axis electrodes 120Y in the vertical projection direction Z, and each of the second axis electrodes 120Y is electrically isolated from each of the first axis electrodes 120X. The first direction X is substantially perpendicular to the second direction Y, but not limited thereto. The first axis electrodes 120X and the second axis electrodes 120Y may be a touch signal driving electrode or a touch signal receiving electrode, cooperating with each other for capacitance touching detection, but not limited thereto. The trace lines 120e disposed in the peripheral region R2 may be used to transmit signals out of or to the first axis electrodes 120X and/or the second axis electrodes 120Y.

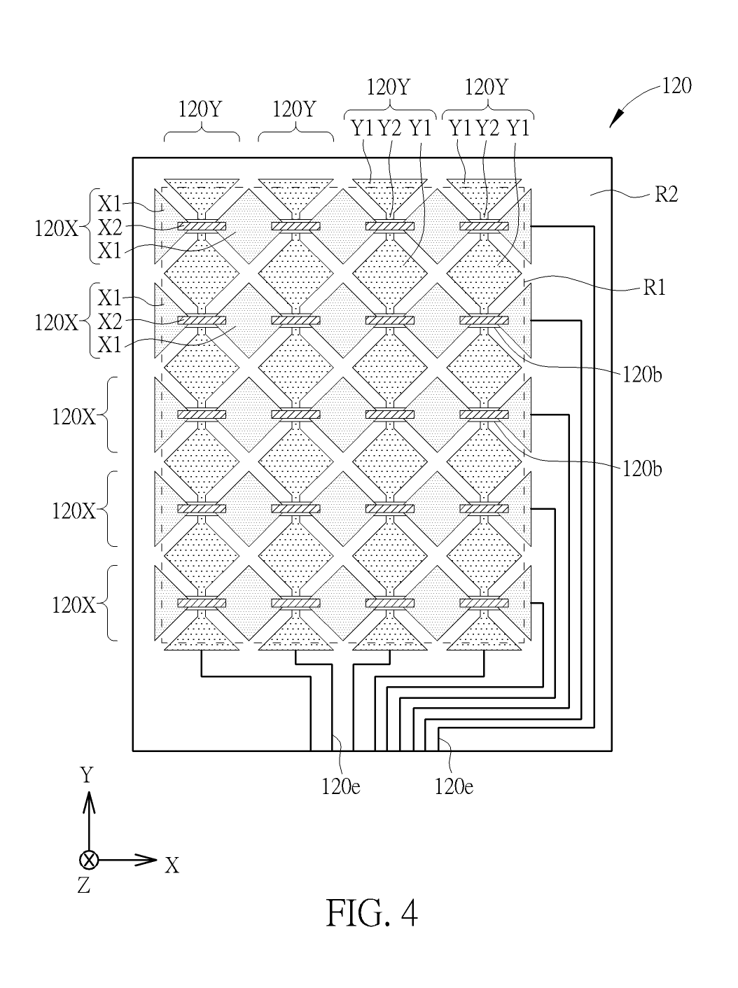

FIG. 4 is a schematic top view showing a layout of touch sensing elements in accordance with another embodiment of the present invention. As shown in FIG. 4, each of the first axis electrodes 120X may also include a plurality of first sub-electrodes X1 and at least one first connecting wire X2 disposed between two adjacent first sub-electrodes X1, and the two adjacent first sub-electrodes X1 are electrically connected to each other through the first connecting wire X2. Each of the second axis electrodes 120Y may also include a plurality of second sub-electrodes Y1 and at least one second connecting wire Y2 disposed between two adjacent second sub electrodes Y1, and the two adjacent second sub-electrodes Y1 are electrically connected to each other through the second connecting wire Y2. Also, the touch device 101 may further include an insulation lump disposed between the first connecting wire X2 and the second connecting wire Y2, thereby electrically isolating the first axis electrodes 120X from the second axis electrodes 120Y, but not limited thereto. Similarly, the trace lines 120e disposed in the peripheral region R2 may be used to transmit signals out of or to the first axis electrodes 120X and/or the second axis electrodes 120Y.

The aforementioned trace lines 120e, the first axis electrodes 120X, the second axis electrodes 120Y, the first sub-electrodes X1, the first connecting wire X2, the second sub-electrodes Y1 and the second connecting wire Y2 are preferably made of transparent conductive materials, such as indium tin oxide (ITO), indium zinc oxide (IZO), aluminum zinc oxide (AZO), a metallic material or another suitable conductive material. The aforementioned metallic material for example may include at least one of aluminum, copper, silver, chromium, titanium, molybdenum, a composite layer of the aforementioned materials, or an alloy of at least one of the aforementioned materials, but not limited thereto; and the aforementioned touch the first axis electrodes 120X and the second axis electrodes 120Y may include a mesh shape, such as metal mesh shape. The aforementioned conductive materials may include conductive particles, carbon nanotube or silver nanowire, but not limited thereto.

The following description details a second embodiment of a touch display device and a touch display device according to the present invention. To simplify the description, the following description will detail the dissimilarities among those embodiments and the variant embodiments, and the identical features will not be redundantly described. For the sake of brevity and clarity, the identical components in each of the following embodiments are marked with identical symbols.

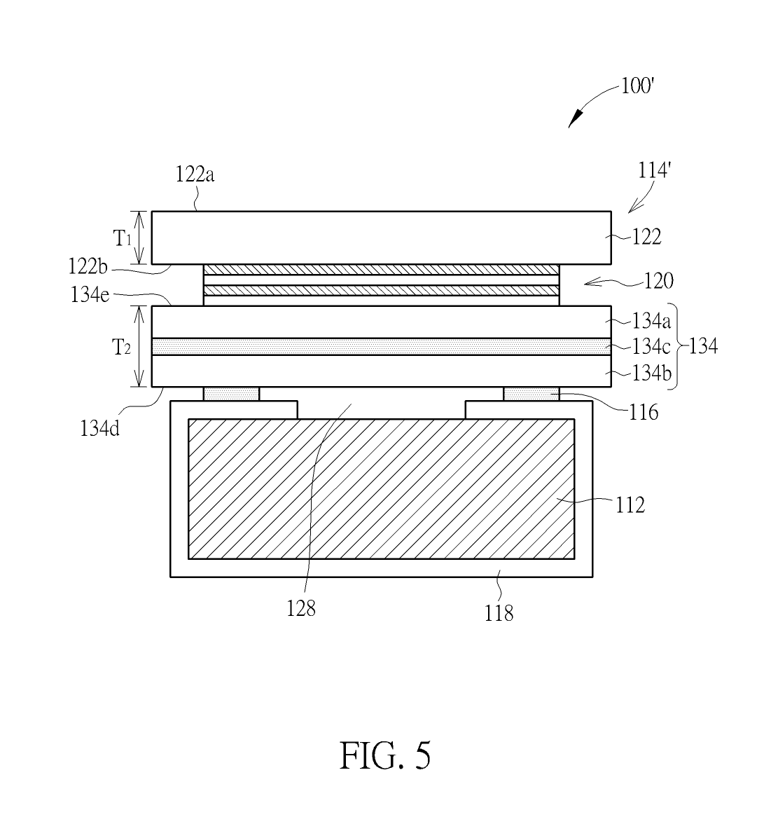

FIG. 5 is a schematic cross-sectional diagram showing a touch display device in accordance with a second embodiment of the present invention. One difference between the present embodiment and the first embodiment is that a dummy structure 134 of a touch display device 100′ includes at least two dummy substrates 134a and 134b and an adhesion layer 134c. The adhesion layer 134c is blanketly disposed between the dummy substrates 134a and 134b so as to integrate the dummy substrates 134a and 134b. The adhesion layer 134c may be chosen form any optical transparent adhesion materials, such as optical clear adhesive (OCA), but not limited thereto. Similarly, the dummy structure 134 may also include an adhesion surface 134a used to combine the dummy structure 134 to the frame 118 of the display device 112. A cover surface 134e may also be included to completely cover one surface of the touch sensing element 120. Because the thickness T1 of the cover 122 is thinner than the thickness T of the cover 22, the touch device 114 may have higher touch sensitivity than that of the touch device 14.

Similarly, the proportion of the thickness T1 of the cover 122 to the thickness T2 of the dummy structure 124 is not limited to a certain value. Preferably, the thickness T1 of the cover 122 is less than or equal to the thickness T2 of the dummy structure 124, and the thickness T1 of the cover 122 is between 0.2 mm to 2 mm, but not limited thereto. Additionally, additional single-layered or multi-layered optical layers, such as anti-reflection layers and/or anti-glare layers, may be optionally disposed on one inner surface of the dummy substrate 134a and 134b or on at least one surface of the dummy structure 134. In addition, a device layer, such as a photodetection device, a photovoltaic device and/or trace lines, may be disposed on these surfaces. Preferably, light with image information, which is emitted from the display device, may not be absorbed by the optical layer and/or the device layer in the viewing region R1. Apart from the structure of the dummy structure 134, which includes two dummy substrates 134a and 134b and one adhesion layer 134c, the rest of the parts of the ouch display device 100′ and touch device 114′ disclosed in this embodiment, such as characteristics and positions of other parts, and material properties are almost similar to those described in the first embodiment. For the sake of brevity, these similar configurations and properties are therefore not disclosed in detail.

To sum up, the dummy structure disposed in the touch device is provided in the embodiments of the present invention. When comparing the touch devices of the present invention and conventional touch devices under an equal mechanical strength, due to the thinned thickness of the cover, the touch devices of the present invention can provide better touch sensitivity without lowering the entire mechanical strength of the touch devices. In this way, the touch devices may have robust mechanical strength and may not be fractured easily during the corresponding adhesion process or operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display device, comprising:
a display device; and
a touch device, disposed on the display device, comprising:
a cover;
a dummy structure, disposed opposite to the cover; and
a touch sensing element, disposed between the cover and the dummy structure, wherein one surface of the touch sensing element is completely covered by the dummy structure.

2. The touch display device of claim 1, wherein the dummy structure is a transparent substrate.

3. The touch display device of claim 1, wherein the dummy structure is a glass substrate or a plastic substrate.

4. The touch display device of claim 1, wherein the dummy structure comprises at least two dummy substrates and an adhesion layer, wherein the adhesion layer is disposed between the dummy substrates.

5. The touch display device of claim 1, further comprising an anti-reflection layer and/or an anti-glare layer on at least one surface of the dummy structure.

6. The touch display device of claim 1, wherein the touch sensing element comprises a plurality of first axis electrodes, a plurality of second axis electrodes and an insulating structure, wherein the insulating structure is disposed between the first axis electrodes and the second axis electrodes so as to electrically isolate the first axis electrodes from the second axis electrodes.

7. The touch display device of claim 1, wherein the cover comprises:
an external surface for receiving a touch pressure from exterior; and
an inner surface opposite to the external surface, wherein the touch sensing element is in direct contact with the inner surface.

8. The touch display device of claim 1, wherein the thickness of the cover is less than or equal to the thickness of the dummy structure.

9. The touch display device of claim 1, wherein the thickness of the cover is between 0.5 mm and 2 mm.

10. The touch display device of claim 1, further comprising an adhesion layer disposed between the display device and the dummy structure so as to combine the dummy structure with the display device through adhesion.

11. The touch display device of claim 10, wherein the adhesion layer is an annular adhesion layer.

12. A touch device, comprising:
a cover, comprising an external surface for receiving a touch pressure from exterior;
a dummy structure opposite to the cover, comprising an adhesion surface adhered to a display device; and
a touch sensing element disposed between the cover and the dummy structure, wherein one surface of the touch sensing element is completely covered by the dummy structure.

13. The touch device of claim 12, wherein the thickness of the cover is between 0.5 mm and 2 mm.

14. The touch device of claim 12, wherein, wherein the thickness of the cover is less than or equal to the thickness of the dummy structure.

15. The touch device of claim 12, wherein the dummy structure has an area substantially equal to the area of the cover.

16. The touch device of claim 12, wherein the dummy structure comprises at least two dummy substrates and an adhesion layer, wherein the adhesion layer is disposed between the dummy substrates.
